(19) United States
(12) Patent Application Publication
(10) Pub. No.: US 2002/0108771 A1
(43) Pub. Date: Aug. 15, 2002

(54) Wrapper for protecting the double electrical cords

(76) Inventor: Ko Fu-Chung, Feng-Yuan City (TW)

Correspondence Address: FU-CHUNG KO, P.O. Box 697, Feng-Yuan City, 420, TW

(21) Appl. No.: 09/788,011

(22) Filed: Feb. 15, 2001

(51) Int. Cl. H01B 11/02

(52) U.S. Cl. 174/117 F

(57) ABSTRACT

A wrapper for protecting the double electrical cords includes a wrapper being made of heavy soft material having a wide flat lower portion and a roof like upper portion which has a slightly arcuate top and a pair of moderate slopes extending downward from the top and then connected to the lateral edges of the lower portion, and a double electrical cords juxtaposedly disposed in the wrapper and extending along the length thereof. It is characterized in that the wrapper can stably attach to a surface of ground without kicking by foot.

### BACKGROUND OF THE INVENTION

The present invention relates to electrical cords and more particularly to a wrapper for protecting the double electrical cords which wrapper including a wide flat lower portion to snugly attach the surface of a ground or of a wall without turning over and a roof like upper portion having slopes extending to the lower portion that leaves no any clearance to be kicked up by foot or bumped off by anything.

Typical double electrical cords 3 (as shown in FIG. 1) laid on the surface of a ground or fixed to a wall are easily to kick up by foot or break loose by something due to its round outer peripheries that could not snugly attach to the surface of the ground or of the wall, therefore causing dangerous.

### SUMMARY OF THE PRESENT INVENTION

The present invention has a main object to provide a wrapper for protecting the double electrical cords which wrapper is made of heavy soft material and having a wide flat lower porting and a roof like upper portion in order to be able to snugly attach to the surface of a ground or of a wall without kicking up by foot or breaking loose by something.

The present invention will become more fully understood by reference to the following detailed description thereof when read in conjunction with the attached drawings.

### BRIEF DESCRIPTION OF THE DRAWINGS

FIG. 1 is a sectional view to show a double cord of the prior art being kicked up by foot,

FIG. 2 is a perspective view of the preferred embodiment according to the present invention, FIG. 3 is a sectional view to show the wrapped double electrical cords of the present invention snugly attached to a ground,

FIG. 4 is a sectional view of FIG. 3 being touched by a foot, and

FIG. 5 is a sectional view to show the wrapped double electrical cords of the present invention being attached to a surface by a double faced tape.

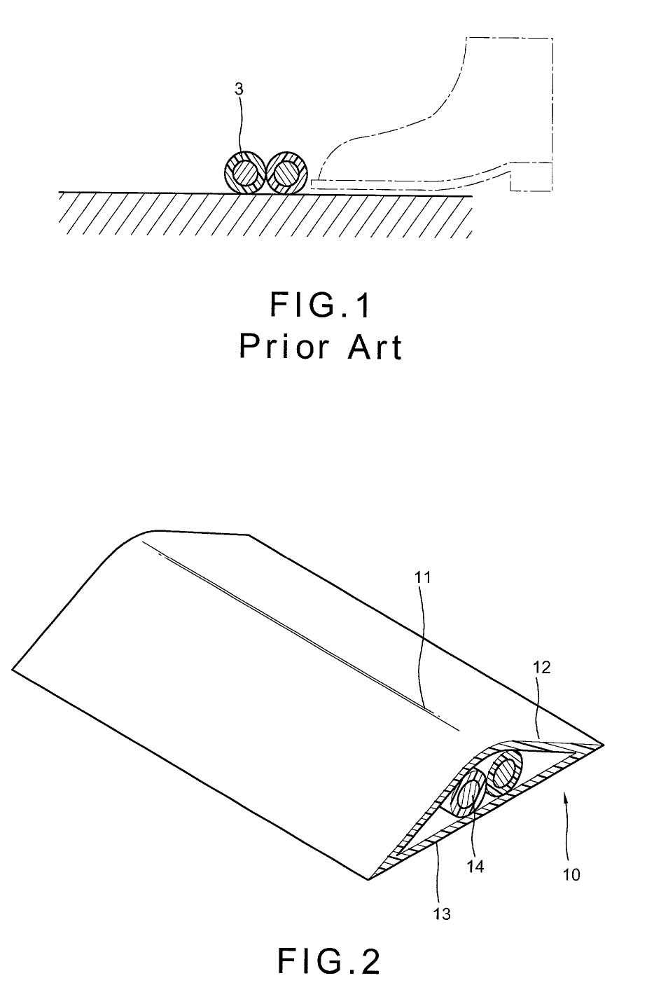

### DETAILED DESCRIPTION OF THE PREFERRED EMBODIMENT

With reference to FIGS. 2, 3 and 4 of the drawings, the wrapper for protecting the double electrical cords of the present invention comprises generally a wrapper 10 and a double electrical cords 14 juxtaposedly disposed in the wrapper 10 and extending along the length thereof.

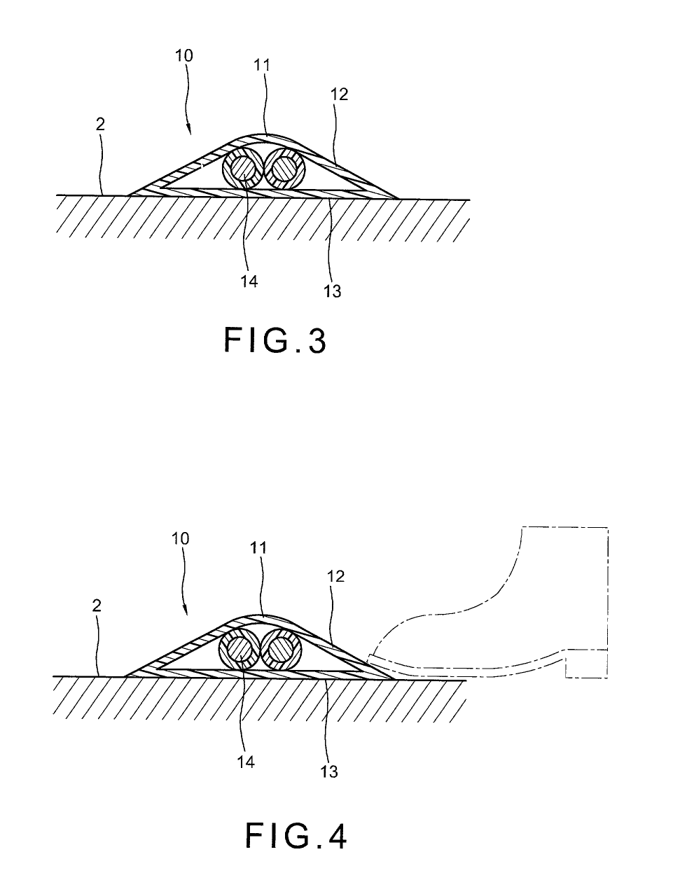

The electrical cords 14 is of conventional type and the wrapper 10 is made of heavy soft material and has a roof like upper portion which includes a slightly arcuate top and a pair of moderate slopes 12 extending downward from the top and a wide flat lower portion 13 have two lateral edges connected to the bottom of the slopes 12. The wide flat lower portion 13 of the wrapper enables to attach to a surface 2 of a ground or of a wall. Due to the heavy soft material, the wrapper 10 can snugly attach to the surface 2 and provide great frictional force between the lower portion 13 of the wrapper 10 and the surface 2 without leaving any clearance therebetween. When a foot kicks on the slope 12 of the wrapper 10 (as shown in FIG. 4), the forward force is dispersed and partially offsetting by the slopes 12, the downward force is also absorbed without moving the wrapper 10.

The features and advantages of the present invention set forth as follows:

a) the wide flat lower portion 13 of the wrapper 10 can be snugly attached to the surface of ground without fixing means due to that it is made of heavy soft material,

b) the slopes 12 of the roof like upper portion of the wrapper 10 can disperse the forward force of the foot so that the wrapper 10 is hardly to be moved away but provides a beautiful outlook, and

c) the wide flat lower portion 13 provide great frictional force therebetween so that the wrapper 10 is hardly to turn over.

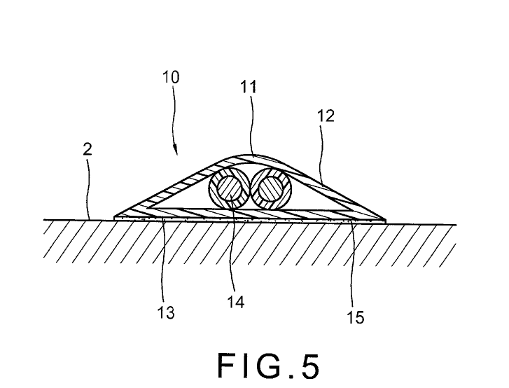

Referring to FIG. 5, a double faced tape 15 may be used to adhere the wrapper 10 to the surface of a ground or of a wall to enable the wrapper 10 to be more stable without using other fittings.

The specification relating to the above embodiment should be construed as exemplary rather than as limitative of the present invention, with many variations and modifications being readily attainable by a person of average skill in the art without departing from the sprit or scope thereof as defined by the appended claims and their legal equivalents.

I claim:

1. A wrapper for protecting the double electrical cords comprising:
a wrapper having a wide flat lower portion and a roof like upper portion which includes a slightly arcuate top and a pair of moderate slopes extending downward from the top and connected to the lateral edges of the lower portion; and
a double electrical cords juxtaposedly disposed in the wrapper and extending along the length thereof.

2. The wrapper as recited in claim 1 wherein said wrapper is made of heavy soft material.

3. The wrapper as recited in claim 1 further has a double faced tape used to adhere said wrapper to the surface of a ground and/or of a wall.
